(19) United States
(12) Patent Application Publication
(10) Pub. No.: US 2025/0004828 A1
(43) Pub. Date: Jan. 2, 2025

(54) HARDWARE-BASED ACCELERATOR SIGNALING

(71) Applicants: ADVANCED MICRO DEVICES, INC., Santa Clara, CA (US); XILINX, INC., San Jose, CA (US)

(72) Inventors: Mark Unruh Wyse, Bellevue, WA (US); Anthony Thomas Gutierrez, Seattle, WA (US); Paul Blinzer, Carnation, WA (US); Samuel Richard Bayliss, San Jose, CA (US)

(21) Appl. No.: 18/216,314

(22) Filed: Jun. 29, 2023

(51) Int. Cl. G06F 9/48; G06F 9/38

(52) U.S. Cl. CPC G06F 9/4881; G06F 9/3877

(57) ABSTRACT

A processor employs a hardware signal monitor to manage signaling for accelerators. The hardware signal monitor monitors designated memory addresses assigned to accelerator signals. In response to a memory write to one of the designated memory addresses, the hardware signal monitor executes a set of one or more operations (referred to as a callback). The hardware signal monitor thereby enables improved and enhanced signaling features, such as asynchronous signaling between agents, inter-accelerator signaling, and inter-process signaling.

### BACKGROUND

To improve processing efficiency and conserve power, some processing systems employ one or more accelerators to perform designated operations on behalf of a central processing unit (CPU). For example, some processing systems employ a graphics processing unit (GPU) to perform graphics operations, an artificial intelligence (AI) accelerator to perform AI operations, a digital signal processor (DSP) to perform signal processing operations, and the like. To facilitate communication between the accelerators and the CPU, some processing systems employ signals, wherein each signal is a shared memory object that can be accessed by the CPU and one or more accelerators to share information. Examples of signals include doorbell signals that notify agents (e.g., one or more accelerators) that work is available, and completion signals that notify agents (e.g., a CPU or accelerator) when assigned work is available. However, existing signal implementations are not well-suited for asynchronous communication, and require a relatively high amount of overhead, such as software polling or interrupts to observe the state of each signal, thus requiring.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a system that employs a hardware signal monitor to manage signals at the system in accordance with some embodiments.

FIG. 2 is a block diagram illustrating aspects of the hardware signal monitor of FIG. 1 in accordance with some embodiments.

FIG. 3 is a block diagram illustrating an example of the hardware signal monitor of FIG. 1 enabling signaling between accelerators in accordance with some embodiments.

FIG. 4 is a block diagram illustrating an example of the hardware signal monitor of FIG. 1 enabling inter-process signaling in accordance with some embodiments.

FIG. 5 is an example of a CPU of FIG. 1 employing page tables to manage the hardware signal monitor of FIG. 1 in accordance with some embodiments.

FIG. 6 is a flow diagram of a method of managing signals at a hardware signal monitor in accordance with some embodiments.

FIG. 7 is a flow diagram of a method of employing a hardware signal monitor to implement a wait process at a system in accordance with some embodiments.

### DETAILED DESCRIPTION

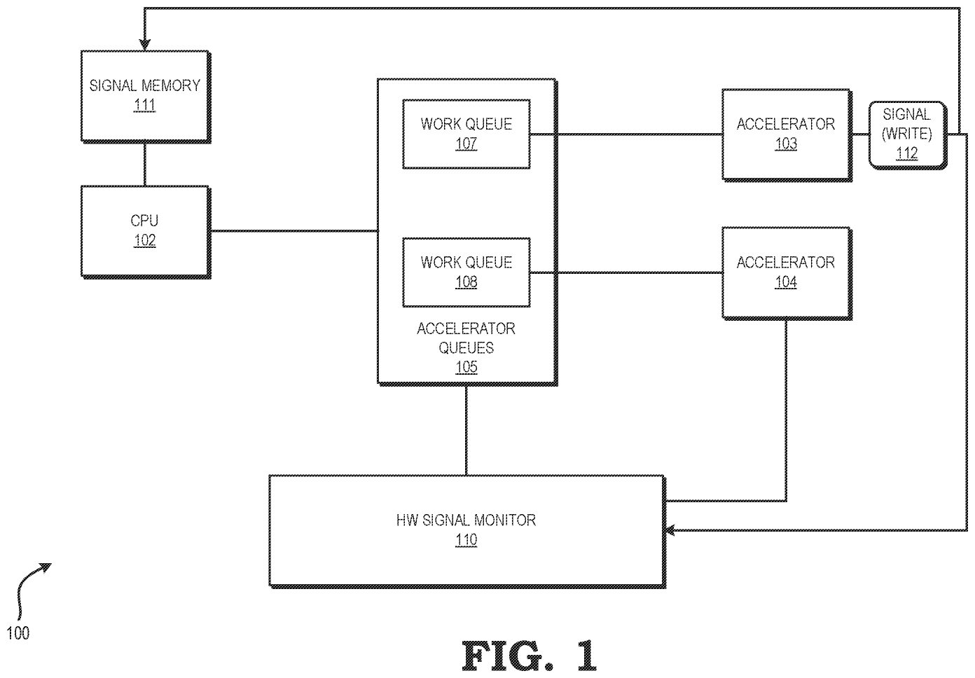

FIGS. 1-7 illustrate circuitry and techniques for employing a hardware signal monitor to manage signaling for accelerators at a system in accordance with some embodiments. The hardware signal monitor monitors designated memory addresses assigned to accelerator signals. In response to a memory write to one of the designated memory addresses, the hardware signal monitor executes a set of one or more operations (referred to as a callback). The hardware signal monitor thereby enables improved and enhanced signaling features, such as asynchronous signaling between agents, inter-accelerator signaling, and inter-process signaling.

To illustrate, in some embodiments a system includes a number of agents, including at least one CPU and two or more accelerators. To communicate, the agents employ a set of signals, wherein each signal is a shared memory-backed object assigned a corresponding memory address. Each signal includes both a signal value and a signal condition. A signal is typically waited on by one or more agents, wherein each agent takes action when the signal condition is met by the corresponding signal value (e.g., the signal condition is met when the signal value is less than one). A signal is sent by an agent when the agent performs a write using an atomic memory operation to the corresponding address. An example of a signal is a doorbell signal, wherein the signal is used by one agent (e.g., a CPU) to indicate to another agent (e.g., an accelerator) that work (e.g., one or more commands) is available to be executed. Another example of a signal is a completion signal, wherein the signal is used by one agent to indicate to another agent that assigned work has been completed.

Conventionally, signals are managed by software polling, interrupts, or a combination thereof. With software polling, software executes a polling loop that repeatedly checks a signal value until the signal condition is met. However, this approach requires a relatively high number of memory accesses (to check the signal value), consuming energy and memory bandwidth. Furthermore, this approach does not allow for true asynchronous signaling, as the software synchronously checks the signal value. With interrupts, the system is configured to trigger a specified interrupt when a corresponding signal condition is met. However, this approach suffers from a relatively high latency and is therefore unsuited for low latency applications. In addition, these approaches are managed by the CPU, thus preventing direct signaling between accelerators, as well as signaling between different executing processes.

Using the techniques described herein, and in contrast to the above approaches, hardware signal monitor circuitry (referred to for simplicity as a hardware signal monitor, or HSM) monitors memory writes to the memory addresses assigned to signals. As noted above, a store operation to one of these memory addresses indicates the sending of a corresponding signal. Accordingly, in response to a store operation directed to one of the memory addresses, the HSM executes a corresponding callback (that is, executes one or more operations corresponding to the callback). Examples of such operations include direct memory access (DMA) operations, issuing interrupts, enqueuing packets into work dispatch queues, and the like, or any combination thereof. The HSM performs monitoring and executing of callbacks independent of the CPU and accelerators, thus reducing signal management overhead, and enabling asynchronous signaling between agents.

Furthermore, because the HSM operates independently of the CPU, the HSM supports direct signaling between accelerators, as well as signaling between different processes executing at the CPU and the accelerators. In addition, in some embodiments the callback operations for one or more of the signals are programmable, thus supporting more sophisticated signal handling, such as callback parsing, conditional signaling, scheduling, and broadcasting, without extensive redesign of the CPU or accelerators.

FIG. 1 illustrates a system 100 in accordance with some embodiments. The system 100 is generally configured to execute sets of instructions (e.g., computer programs) in order to carry out operations, as specified by the sets of instructions, on behalf of an electronic device. Accordingly, in different embodiments the system 100 is part of any one of a number of electronic devices, such as a desktop or laptop computer, a server, a smartphone, a tablet, a game console, and the like.

To facilitate execution of instructions, the system 100 includes a CPU 102 and a set of accelerators (e.g., accelerators 103 and 104). It will be appreciated that the number of accelerators illustrated at FIG. 1 is an example only, and that in other embodiments the system 100 includes more or fewer accelerators. In addition, in some embodiments the system 100 includes additional circuitry, not illustrated at FIG. 1, that supports the execution of instructions, such as one or more memory controllers, one or more input/output controllers, one or more memory modules, and the like, or any combination thereof. In some embodiments the CPU 102 and the accelerators 103 and 104 are part of a single processor. In other embodiments one or more of the accelerators 103 and 104 is external to the system 100. In other embodiments, the CPU 102 and the accelerators 103 and 104 are part of the same integrated circuit package but are incorporated in separate integrated circuit dies.

The CPU 102 is generally configured to execute sets of instructions for the system 100. Thus, in some embodiments, the CPU 102 includes one or more processor cores, wherein each processor core includes one or more instruction pipelines. Each instruction pipeline includes circuitry configured to fetch instructions from a set of instructions assigned to the pipeline, decode each fetched instruction into one or more operations, execute the decoded operations, and retire each instruction once the corresponding operations have completed execution. In the course of executing at least some of these operations, the CPU 102 generates operations to be executed by one of the accelerators 103 and 104.

Each of the accelerators 103 and 104 is circuitry configured to execute specified operations on behalf of the CPU 102. For example, in different embodiments each of the accelerators 103 and 104 is one of a GPU, a vector processor, a general-purpose GPU (GPGPU), a non-scalar processors, a highly-parallel processor, an artificial intelligence (AI) processor, an inference engine, a machine learning processor, a DSP, a network controller, and the like. Further, in at least some embodiments each of the accelerators 103 and 104 is a different type of accelerator.

To facilitate communication of operations, and the results of operations, between the CPU 102 and the accelerators 103 and 104, the system 100 includes accelerator queues 105. In some embodiments, the accelerator queues 105 includes one or more work queues (e.g., work queues 107 and 108) wherein each work queue stores information, such as commands and corresponding data for the accelerators to instantiate and carry out operations. For example, in some embodiments the CPU 102 sends an operation (also referred to as a work item) to the accelerator 103 by storing a packet indicating the operation, and any corresponding data, at the work queue 107. The accelerator 103 retrieves packets from the work queue 107, determines the operation indicated by the packet, and executes the indicated operation. The CPU 102 similarly employs the work queue 108 to provide operations to the accelerator 104.

To support further communication between the CPU 102 and the accelerators 103 and 104, the system 100 is configured to support a signals architecture, such as a Heterogeneous Systems Architecture (HAS). In particular, the CPU 102 and the accelerators 103 and 104 are configured to communicate specified information, such as status information, via a set of signals, wherein each signal is a shared memory object accessible by at least two of the CPU 102, the accelerator 103, and the accelerator 104. To support signals, the system 100 includes a signal memory 111 including a plurality of addressable entries, wherein each entry corresponds to a different signal. To change the state of a signal, an accelerator or the CPU 102 performs a write operation (e.g., write 112) to the memory address corresponding to the signal. The value written by the write operation sets the value for the signal corresponding to the memory address.

To illustrate via an example, in some embodiments an operating system (not shown) or other software executing at the CPU 102 assigns a memory address as a doorbell signal for the accelerator 103, wherein the value of the signal is to indicate whether the accelerator 103 is available to handle additional work items from the CPU 102. Thus, when the accelerator 103 determines that it is able to process more work items, the accelerator 103 writes a specified value to the memory address, at the signal memory 111, assigned to the doorbell signal. In response, the CPU 102 provides one or more additional work items to the work queue 107. It will be appreciated that, in different embodiments, the signal memory 111 stores the values for any number of signals, and to indicate any of a number of statuses or other information, such as signals indicating completion of one or more work items by an accelerator, signals indicating that a specified action is to be taken by the CPU 102, and the like.

As noted above, one way for the CPU 102 and the accelerators 104 and 104 to determine the status of a given signal is to poll the signal, such as by performing a read operation at the memory address specified by the signal. However, this requires the CPU 102, for example, to repeatedly execute polling loops for the signal, consuming CPU resources and preventing asynchronous communication of signal statuses. Accordingly, to facilitate more efficient communication of signals, as well as more sophisticated signal handling, the system 100 includes a hardware signal monitor (HSM) 110. The HSM 110 is circuitry that is configured to monitor write operations to the signal memory 111 and, in response to a write operation to a given signal, execute one or more specified operations for the signal. The one or more specified operations is referred to as a callback for the signal.

In different embodiments, the HSM 110 identifies signal writes in any of a number of different ways. For example, in some embodiments the accelerators 103 and 104 and the CPU 102 are all connected to the signal memory 111 via a common memory bus (not shown). The HSM 110 is configured to store a table of memory addresses assigned to each signal, and to snoop the common memory bus for memory writes. In response to identifying, based on the snooping, a memory write to an address stored in the table, the HSM 110 executes the corresponding callback. In other embodiments, the monitoring circuitry of the HSM 110 is located in a memory controller (not shown) that manages write operations to the signal memory 111. In these embodiments, the memory controller provides to the HSM 110 each write operation (or each write operation to a specified address range), and the HSM 110 determines whether the write operation is to the signal memory 111. By using the HSM 110 to monitor signals, signal management overhead at the system 100 is reduced. Furthermore, and as described further below, in some embodiments the HSM 110 supports relatively sophisticated signal handling, including inter-accelerator and inter-process signaling, as well as programmable callbacks for signals.

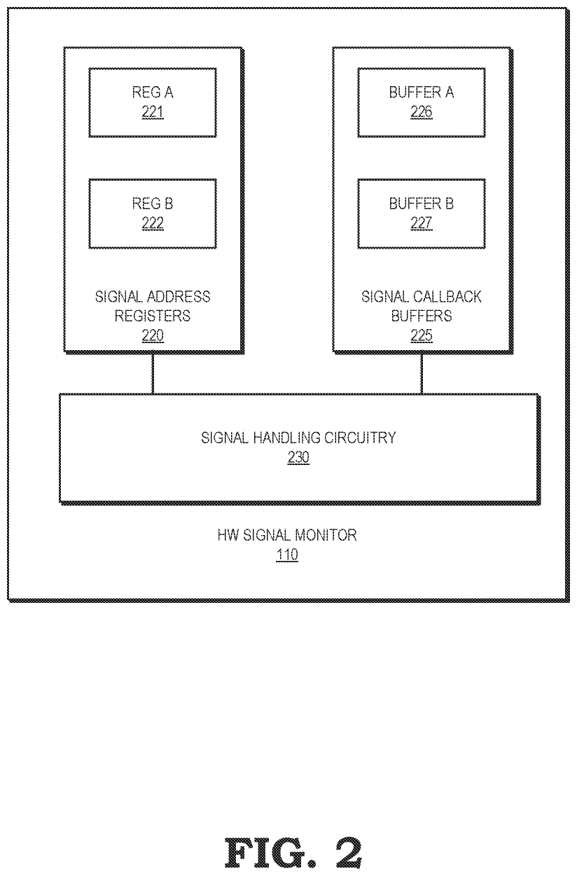

FIG. 2 is a block diagram illustrating aspects of the HSM 110 in accordance with some embodiments. In the depicted example, the HSM 110 includes signal address registers 220, signal callback buffers 225, and signal handling circuitry 230. The signal address registers 220 are a plurality of registers (e.g., registers 221 and 222) wherein each register stores the address assigned to a signal. In some embodiments, the address value at each of the signal address registers 220 is stored by an operating system, device driver, or other software executing at the CPU 102. For example, in some embodiments an operating system assigns, during an initialization or boot process for the system 100, a memory address to each signal to be used by the accelerators 103 and 104 and stores each assigned memory address at a different one of the signal address registers 220.

The signal callback buffers 225 are a plurality of buffers (e.g., buffers 227 and 228) wherein each buffer stores a set of operations assigned to a signal. In different embodiments, the operations are identified by the data stored at the signal callback buffers 225 in different ways. For example, in some embodiments, each buffer stores a set of instructions to be executed by a microcontroller, processor, or instruction pipeline, wherein the set of instructions indicate the operations to be executed in response based on the value of the corresponding signal. In other embodiments, each buffer stores an indication of an initial state (or set of states) for a state machine, wherein the initial state indicates the set of operations to be executed in response based on the value of the corresponding signal. Examples of operations that, in different embodiments, are stored at the signal callback buffers 225, and that are executed based on the values of the corresponding signals, include one or more of DMA or other memory transfers of one or more bytes, an atomic memory operation, an enqueue or dequeue operation of a packet from a software- or hardware-backed queue, a task dispatch operation, a chain of signal operations, and program instructions to be executed signal handling circuitry, a command processor, an accelerator, or another processor, or any combination thereof.

The signal handling circuitry 230 is a set of circuitry with at least two aspects: circuitry to monitor the writing of signal values at the signal memory 111, and circuitry to execute operations based on the signal values. In some embodiments, to execute the operations, the signal handling circuitry 230 includes a microcontroller or microprocessor configured to execute instructions stored at the signal callback buffers 225. In other embodiments, the signal handling circuitry 230 is circuitry configured to execute one or more state machines, wherein the initial state for a state machine is indicated by information stored at the signal callback buffers 225. Thus, to execute a set of operations for a signal, the signal handling circuitry 230 accesses the corresponding one of the signal callback buffers 225 and, based on the indicated set of operations, determines both the initial state at the one or more state machines, as well as the transitions between different states.

In operation, the signal handling circuitry 230 monitors writes to the signal memory 111, and in particular monitors for writes to the memory addresses stored at the signal address registers 220. In response to identifying a write to one of the stored addresses, the signal handling circuitry 230 executes the set of operations at a corresponding one of the signal callback buffers 226. To illustrate, in some embodiments the buffer 226 stores the callback (the set of operations to be executed) for the signal associated with register 221. That is, register 221 stores the memory address for a given signal, and the buffer 226 stores the callback for that signal. Similarly, the register 222 stores the memory address for a different signal, and the buffer 227 stores the callback for the signal corresponding to the memory address stored at the register 222. In response to identifying a memory write to the address stored at the register 221, the signal handling circuitry 230 executes the callback at the buffer 226. Similarly, in response to identifying a memory write to the address stored at the register 222, the signal handling circuitry 230 executes the callback stored at the buffer 227.

The HSM 110 supports enhanced signal handling at the system 100 in accordance with some embodiments. For example, in some embodiments the signal handling circuitry 230 identifies the writing of signal values, and executes corresponding callbacks, in parallel with and asynchronously with 1) instructions being executed at the CPU 102; 2) operations being executed at the accelerators 103 and 104; or 3) any combination thereof. This obviates the need for the CPU 102 to execute polling loops to check signal values, reducing signal management overhead at the CPU 102 and improving overall processing efficiency.

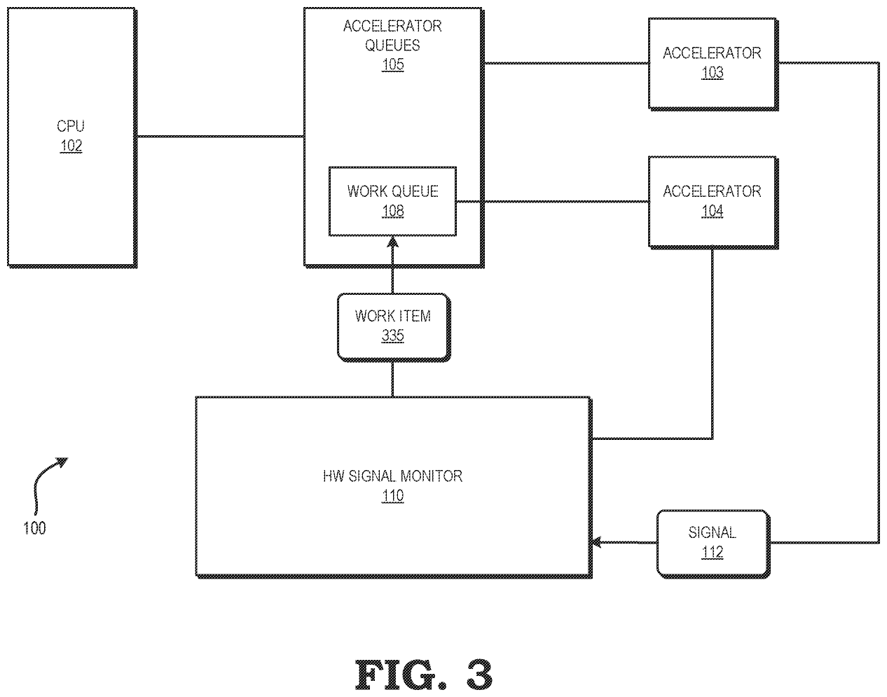

In addition, as noted above the signal handling circuitry 230 is able to execute one or more callbacks (that is, one or more sets of operations) in response to different signal values. This allows the HSM 110 to perform more complex signal handling, and to support inter-accelerator communications and inter-process signaling. An example of the HSM supporting inter-accelerator signaling is illustrated at FIG. 3 in accordance with some embodiments. In the illustrated example, the accelerator 103 performs the memory write 112 to write a value to the corresponding signal. In response to the memory write 112, the HSM 110 executes a corresponding callback. One of the operations of the executed callback is to store a work item 335 at the work queue 108. The work item 335 indicates a set of operations to be executed by the accelerator 104. The accelerator 104 retrieves the work item 335 from the work queue 108 and executes the indicated operations. Thus, in the example of FIG. 3, the accelerator 103 uses a signal to directly schedule work for execution at the accelerator 104, rather than requesting the CPU 102 to provide the work item 335. That is, in some embodiments the accelerators 103 and 104 use signals to schedule work directly at other accelerators, without intervention or management by the CPU 102, and thus improving overall processing efficiency at the system 100.

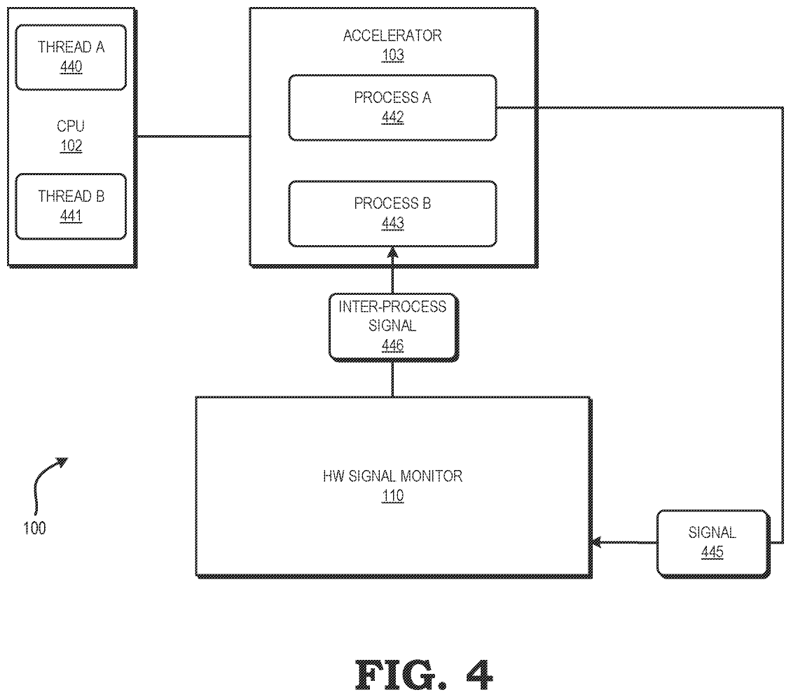

FIG. 4 illustrates an example of the HSM 110 enabling inter-process signaling in accordance with some embodiments. In the illustrated example, the CPU 102 concurrently executes two threads, designated threads 440 and 441, wherein each of the threads 440 and 441 represents a set of instructions (e.g., a program thread) executing at an instruction pipeline of the CPU 102. Further, each of the threads 440 and 441 instantiates and manages a different process, designated process 442 and process 443 at the accelerator 103. Each of the processes 442 and 443 represent a set of operations to be executed at the accelerator 103 on behalf of the corresponding thread. For example, in some embodiments the accelerator 103 is a GPU, and the processes 442 and 443 represent different draw operations executed by the GPU on behalf of threads 440 and 441, respectively.

In a conventional processor, the processes 442 and 443 are not able to directly communicate via signals. Instead, each process communicates with other processes via the corresponding threads. In the depicted example, however, the HSM 110 generates an inter-process signal 446 to communicate information directly between the processes 442 and 443. In particular, in response to the process 442 sending a signal 445 (that is, performing a memory write of a value to a memory location corresponding to the signal 445), the HSM 110 executes a corresponding callback. One of the operations of the callback, when executed, generates an inter-process signal 446 communicated directly to the process 443. Thus, the process 442 communicates information, via a signal, to the process 443 directly, without intervention by the corresponding threads 440 and 441. The HSM 110 thus supports flexible and efficient communication of information between processes, enabling synchronization of operations between processes, and thus supporting more complex task pipelines.

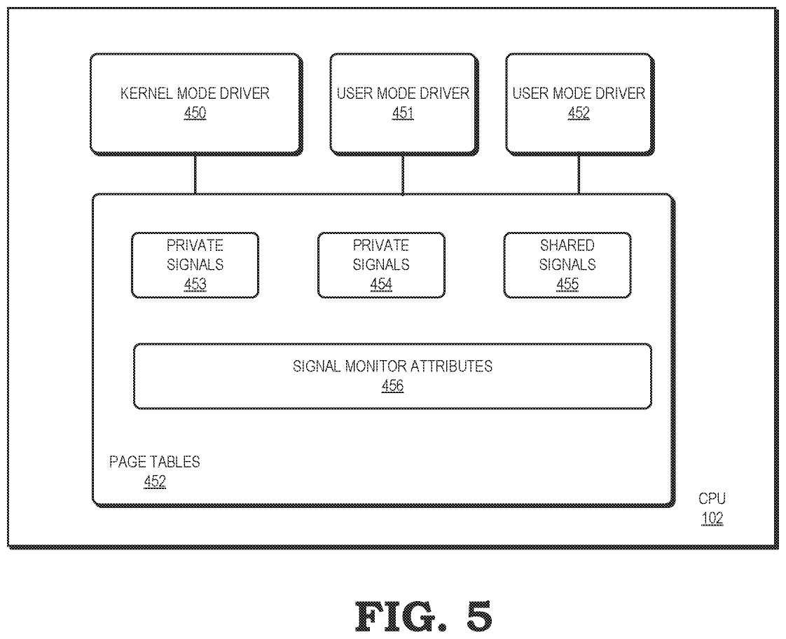

In some embodiments, the CPU 102 employs page tables to manage signaling and the HSM 110. An example is illustrated at FIG. 5 in accordance with some embodiments. In the depicted example, the CPU 102 executes a kernel mode driver (KMD) 450 and user mode drivers (UMDs) 451 and 452. In some embodiments, the KMD 450 is a software component that runs in the same memory space as an operating system (OS, not shown) executing at the CPU 102. Each of the UMDs 451 and 452 is a software component for a corresponding accelerator (accelerators 103 and 104, respectively). Each of the UMDs 451 and 452 execute in a separate memory space from the OS.

In some embodiments the KMD 450 allocates pages of memory that (a) support user-mode monitor-based signals and (b) are shared across multiple user-mode processes (virtual address) spaces. The KMD 450 and OS allocate suitable physical memory pages to represent the signals to be used by the system 100. Each of the UMDs 451 and 452 is configured to request and use signals allocated from shared pages by the KMD 450. Furthermore, each UMD 451 and 452 executes in an independent process address space and therefore has its own mappings from user-process virtual address to the physical address of the signal. In some embodiments, each UMD 451 and 452 executes a monitor-based wait operation on the shared signal, as described further below.

In one embodiment, the KMD 450 controls access to a set of shared signals 455 used for inter-process communication. The UMDs 451 and 452 call into the KMD 450 to request a new shared signal or access an existing shared signal. In another embodiment, either or both of the UMDs 451 and 452 are configured to control access to shared signals. In some embodiments, a signal is created in response to one of the UMDs 451 and 452 calling the KMD 450 to allocate a shared signal in an appropriate page of memory. In some embodiments, the UMD then grants access to the signal to other UMDs to enable inter-process communication. In the illustrated example, the KMD 450 also allocates private signals 453 and 454, representing signals dedicated to a particular accelerator 103 and 104.

In some embodiments, each user-process uses the same virtual address for a shared signal. The KMD 450 and OS collaborate to install consistent virtual address translations for each UMD sharing signals at page tables 452, thereby creating an abstraction of a single shared memory space for the shared signals. Using the same

virtual address across all agents and user-mode processes for a given signal allows the signal handle (address) to be passed seamlessly between processes and accelerators without need for virtual-to-virtual address translations. For example, in some embodiments one process dispatches a task to an accelerator and communicates the address of a completion signal to another process whose accelerator task is dependent on the first process. The dependent process then uses a monitor-based signal wait operation, as described below, targeting the provided virtual address of an allocated signal to wait for completion of the first task. When the completion signal is sent, the dependent process will receive notification, wake up, and dispatches its accelerator task, thereby forming a multi-process accelerator task pipeline. The use of monitor-based signals directly enables the inter-process synchronization without requiring high latency inter-process interrupts.

In some embodiments, a virtual memory system of the OS uses the page tables 452 to provide virtual to physical address translation and memory protection. The metadata of page table entries indicates the availability of hardware-supported address monitors or monitor-based signal mechanisms for memory pages. This metadata is represented at FIG. 5 as signal monitor attributes 456. For example, in some embodiments the signal monitor attributes includes OS-available bits that indicate if virtual addresses belonging to the page are allowed to be targeted by a hardware address monitor. A runtime queries the status of the signal monitor attributes 456 to dynamically, at runtime, determine whether a monitor-based signal implementation may be used by the runtime. In different embodiments, the OS, KMD 450, or runtime are responsible for querying the hardware function registers to detect hardware address monitoring support and set the signal monitor attributes 456 based on the query. This enables page-granularity selection of monitor wait mechanisms. That is, in some embodiments some signals are indicated by the signal monitor attributes 456 as monitorable, and other signals are indicated as non-monitorable. The HSM 110 monitors only those signals indicated as monitorable by the signal monitor attributes 456.

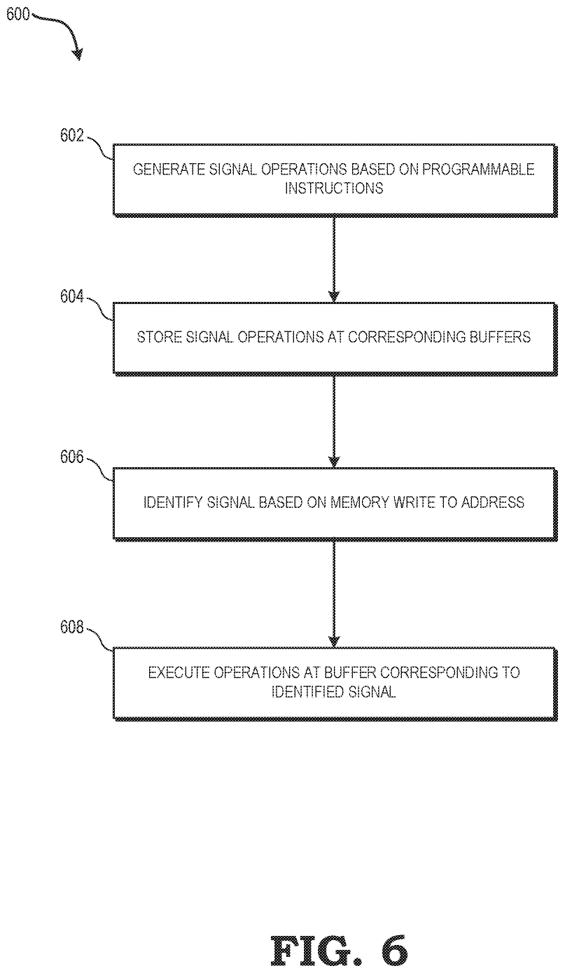

FIG. 6 illustrates a flow diagram of a method 600 of managing signals at a hardware signal monitor in accordance with some embodiments. The method 600 is described with respect to an example implementation at the system 100, but it will be appreciated that in other embodiments the method 600 is implemented at a system having a different configuration.

At block 602, the CPU 102 generates the signal operations, also referred to herein as callbacks, for each signal. For example, in some embodiments one or more application program interface (APIs) provides the set of operations for each signal based on instructions provided by one or more programmers. This allows the programmers to tailor the operations executed for each signal, as well as set different operations to be executed for different signal values. At block 604, the CPU 102 stores the different signal operations for each signal at corresponding ones of the signal callback buffers 225.

At block 606, the signal handling circuitry 230 monitors a memory bus for write operations to memory addresses stored at the signal address registers 230. In response to determining that a write operation is targeting one of the stored addresses, the signal handling circuitry determines that a signal value is being set for the corresponding signal. Accordingly, at block 608 the signal handling circuitry identifies the callback buffer associated with the identified signal, and then executes the set of operations stored at the identified callback buffer.

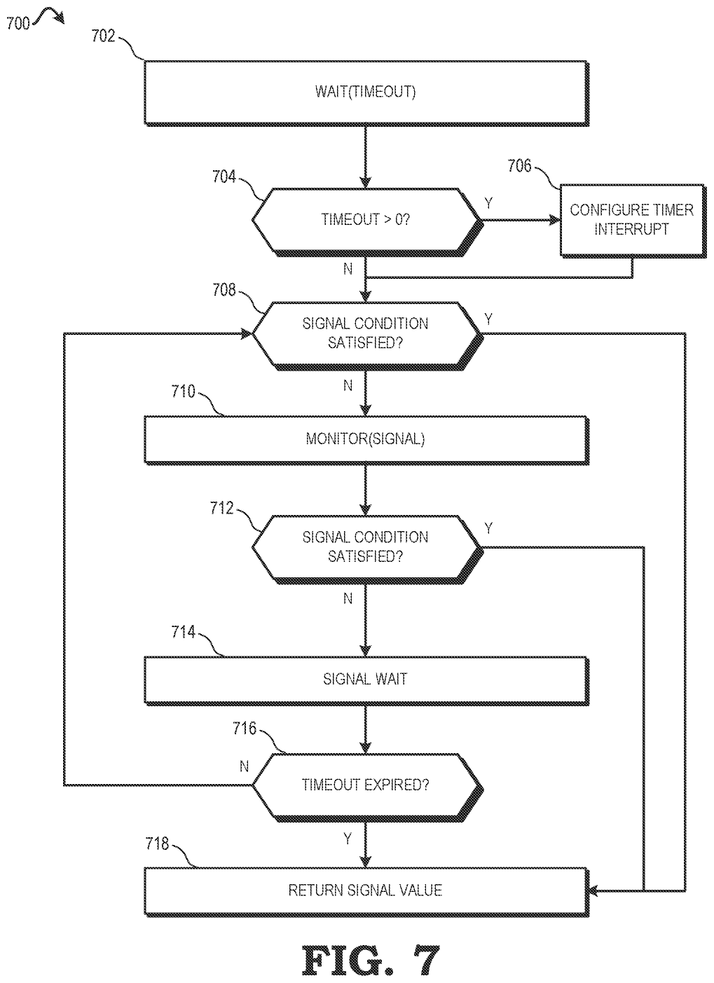

FIG. 7 illustrates a flow diagram of a method 700 of a signal wait operation executed by a hardware signal monitor of a system in accordance with some embodiments. The method 700 is described with respect to an example implementation at the system 100, but it will be appreciated that in other embodiments the method 600 is implemented at a system having a different configuration.

In some embodiments, the method 700 is executed as part of the set of callback operations in response to a corresponding signal. The callback operation indicates that the signal handling circuitry is to execute a signal wait operation. To execute the signal wait operation, at block 702 the signal handling circuitry 230 optionally configures a user-timeout request, thereby waiting to check any signal condition until the timeout amount is satisfied. At block 704, the signal handling circuitry determines if the timeout level is greater than zero. If not, the method flow moves to block 708, described below. If the timeout level is greater than zero, the method flow moves to block 706 and the signal handling circuitry configures a timer interrupt. In some embodiments, the timer interrupt provides a latency boundary for checking the signal value. For example, in some embodiments, the software that invokes the monitor may desire a notification regarding the signal after the timeout latency has expired, even if the signal value does not yet meet the specified condition. In some embodiments, the timer interrupt is used to determine whether the entity that is expected to write the signal has stalled or is overloaded with work. After the timer interrupt is configured, the method flow then moves to block 708.

At block 708, the signal handling circuitry 230 determines if the signal condition for the signal is satisfied. If so, the method moves to block 718 and the signal handling circuitry 230 returns the signal value. If the signal condition is not satisfied, the method flow moves to block 710 and the signal handling circuitry 230 executes a monitor operation for the signal. In response to the monitor operation, a hardware signal monitor is assigned to monitor for the signal condition being satisfied. At block 712, the signal handling circuitry 230 determines if the signal condition for the signal has been satisfied while the hardware signal monitor was being set up. If so, the method moves to block 718 and the signal handling circuitry 230 returns the signal value.

If, at block 712, the signal condition has not been satisfied, the method flow moves to block 714 and the signal handling circuitry 230 executes a wait operation for a specified amount of time. In some embodiments, in response to the wait operation, the system 100 enters a halt state or other defined state. Upon termination of the wait operation (e.g., in response to a wake up of the system 100), the method flow moves to block 716 and the signal handling circuitry 230 determines if the timeout for the signal has expired. If not, the method flow returns to block 708. If the timeout for the signal has expired the method flow moves to block 718 and the signal handling circuitry returns the signal value.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
based on a signal issued by a first accelerator, asynchronously notifying, by a hardware signal monitor, a first process of the signal.

2. The method of claim 1, wherein asynchronously notifying comprises:
executing, at the hardware signal monitor, a set of operations based on the signal.

3. The method of claim 2, wherein the set of operations includes one or more of a memory transfer of one or more bytes of data, an atomic memory operation, an enqueuing of a first packet, a dequeuing of a second packet, a task dispatch operation, a set of signal operations, and an instruction to be executed by a processor.

4. The method of claim 2, wherein the set of operations includes the hardware signal monitor sending a task to a second accelerator.

5. The method of claim 4, wherein sending the task comprises the hardware signal monitor sending the task based on a value generated by one of a plurality of accelerators.

6. The method of claim 4, wherein sending the task comprises enqueuing the task at a work queue of the second accelerator.

7. The method of claim 2, wherein the set of operations is programmable.

8. The method of claim 1, wherein the signal is issued by a second process executing at the first accelerator, the second process independent of the first process.

9. The method of claim 1, wherein the signal is issued by the first accelerator in response to a write operation to a specified memory address.

10. A method, comprising:
receiving, at a hardware signal monitor, a signal from a first process, the signal associated with a first accelerator; and
indicating, by the hardware signal monitor, the signal to a second process, the second process independent of the first process.

11. The method of claim 10, wherein the second process is associated with a second accelerator of the processor.

12. A system, comprising:
a first accelerator; and
hardware signal monitor circuitry to:
based on a signal associated with the first accelerator, asynchronously notify a first process of the signal.

13. The system of claim 12, wherein the hardware signal monitor circuitry includes:
signal handling circuitry to execute a set of operations based on the signal.

14. The system of claim 13, wherein the set of operations includes one or more of a memory transfer of one or more bytes of data, an atomic memory operation, an enqueuing of a first packet, a dequeuing of a second packet, a task dispatch operation, a set of signal operations, and an instruction to be executed by a processor.

15. The system of claim 14, wherein the set of operations includes the hardware signal monitor circuitry sending a task to a second accelerator.

16. The system of claim 15, wherein the hardware signal monitor circuitry is to send the task based on a value generated by one of a plurality of accelerators.

17. The system of claim 15, wherein the hardware signal monitor circuitry is to send the task to a work queue of the second accelerator.

18. The system of claim 14, wherein the set of operations is programmable.

19. The system of claim 12, wherein the signal is issued by a second process, the second process independent of the first process.

20. The system of claim 12, wherein the signal is based on a write operation to a specified memory address.
